(19) United States
(12) Patent Application Publication
(10) Pub. No.: US 2025/0323561 A1
(43) Pub. Date: Oct. 16, 2025

(54) Integrated Electromagnetic and Piston Drive System for High-Efficiency Load Pulling

(71) Applicant: Huy Nguyen, Midway City, CA (US)

(72) Inventor: Huy Nguyen, Midway City, CA (US)

(21) Appl. No.: 19/085,375

(22) Filed: Mar. 20, 2025

Related U.S. Application Data
(60) Provisional application No. 63/632,143, filed on Apr. 10, 2024.

(51) Int. Cl. H02K 49/10

(52) U.S. Cl. CPC H02K 49/108

(57) ABSTRACT

The present invention relates to an electric engine magnet field power compress device designed to generate a powerful pull load force by combining electromagnetic and piston power. The device includes a pair of rotors with embedded magnets for producing a magnetic field to drive mechanical components. A motor-driven rotary shaft, featuring specific bends, transfers rotational force from the rotors to a gear train to convert high-speed rotation into a powerful pulling force. A piston is connected to the shaft generates linear thrust to enhance the pulling power. The device integrates the linear and rotational thrusts to maximize force output, making it suitable for heavy-duty applications like pulling trucks or haulers.

### CROSS-REFERENCE TO RELATED APPLICATION

The present application claims priority to, and the benefit of, U.S. Provisional Application No. 63/632,143, which was filed on Apr. 10, 2024, and is incorporated herein by reference in its entirety.

### FIELD OF THE INVENTION

The present invention generally relates to the field of electric power generation systems for heavy-duty vehicles. More specifically, the present invention relates to an electric engine magnet field power compress device designed to enhance the pull load force in electric trucks and haulers. The device comprises a pair of rotors with embedded magnets to generate a magnetic field, a motor-driven rotary shaft with bends for efficient force transmission, and a piston to produce linear thrust. The device enables powerful and controlled pulling of heavy loads, improving the performance and efficiency of electric vehicles. Accordingly, this disclosure makes specific reference thereto the present invention. Nonetheless, it is to be appreciated that aspects of the present invention are also equally applicable to other like applications, devices, and methods of manufacture.

### BACKGROUND

By way of background, pull load force is important in automotive vehicles and especially for trucks, haulers, and other heavy-duty vehicles. Such vehicles are designed to transport substantial loads, such as cargo, machinery, and equipment, often over long distances and through varying terrains. However, the automotive industry faces significant challenges related to pull load force. While electric vehicles have made considerable advancements in efficiency and sustainability, achieving a balance between powerful pulling force and operational speed remains problematic for larger vehicles like trucks and haulers.

Standard rotary engines used in smaller vehicles are not suitable for heavy vehicles due to their limited capacity to generate the substantial pull load force required for larger weights. The use of rotary engines for heavy-duty applications is ineffective, as rotary engines cannot produce the necessary torque and power without compromising speed. Also, conventional internal combustion engines running on gas or diesel can generate adequate power, but demand maintenance and are less environmentally friendly. People desire an innovative solution that can provide electric trucks and haulers with both the required pull load force and sufficient speed.

Therefore, there exists a long-felt need in the art for an electric engine system that can enhance the pull load force of electric trucks and heavy-duty vehicles. There is also a long-felt need in the art for a pull load generation system that reduces the dependency on traditional internal combustion engines. Additionally, there is a long-felt need for a pulling mechanism that combines the advantages of electromagnetic and mechanical systems to produce a powerful and controlled pull force suitable for moving heavy loads like cargo, machinery, and trailers. Moreover, there is a long-felt need for an electric pulling device that can be easily integrated into existing vehicles. Further, there is a long-felt need for a pulling system that offers precise control over the pulling force to ensure safe and efficient operation in diverse terrains and conditions. Finally, there is a long-felt need in the art for a device that maximizes the power-to-weight ratio of electric vehicles, improving both their performance and operational efficiency.

The subject matter disclosed and claimed herein, in one embodiment thereof, comprises an electric engine magnet field power compress device designed to provide an effective solution for enhancing the pull load force in electric trucks and heavy-duty vehicles. The device includes a pair of rotors containing magnets, which can be in the form of electromagnetic coils or permanent magnets, to generate a strong magnetic field. A motor-driven rotary shaft extends between the rotors and has a gear train. A piston is operatively connected to the shaft to provide additional linear thrust on a flat surface to further amplify the pulling power. The device combines the linear thrust from the piston with the rotary thrust from the motor-driven shaft to enable the pulling of large vehicles and heavy machinery with greater speed and efficiency.

In this manner, the electric engine magnet field power compress device of the present invention accomplishes all of the foregoing objectives and provides a novel device to enhance pull load force in electric vehicles. The device uses a combination of electromagnetic force and piston-driven mechanical thrust to provide a more powerful and controlled pulling mechanism that is suitable for various heavy-duty applications. The magnetic field produced by the rotors eliminates the need for bulky internal combustion engines, reducing maintenance requirements and promoting an environmentally friendly solution. The integration of a gear train and a uniquely designed shaft with bends allows for efficient transmission of force, converting rotational energy into a high pull load force.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electric engine magnet field power compress device for generating a pull load force. The device includes a pair of rotors configured to produce a magnetic field; each rotor has electromagnetic coils. A rotary shaft extends between the rotors, the shaft has a circular cross-section and includes a first bend and a second bend, the bends configured to facilitate connection to a piston for converting rotational force into linear thrust, a gear train comprising a set of interconnected gears disposed between the rotors, the gear train is configured to convert high-speed rotation into a powerful pull load force. A piston is operatively connected to the shaft; the piston is configured to generate thrust on a flat surface through linear motion induced by the rotational movement of the shaft. The device is configured to combine the linear thrust generated by the piston and the rotational thrust generated by the shaft to maximize the pull load force for pulling heavy objects.

In another aspect, the device includes magnetic connectors disposed on the bent portion of the shaft, the connectors are adapted to slide along the shaft to facilitate the linear movement of the piston. A control module is operatively connected to the device, the control module is configured to regulate the electric current supplied to the electromagnetic coils of the rotors, thereby managing the rotational and linear force output of the device.

In another embodiment, a vehicle system for pulling heavy loads is disclosed. The system includes an electric engine magnet field power compress device securely mounted to a frame or chassis of the vehicle. The device comprises a pair of rotors having electromagnetic coils configured to produce a magnetic field, a motor-driven rotary shaft extends between the rotors and includes a first and second bend, a piston is operatively connected to the shaft and is configured to generate a linear thrust, and a gear train is configured to convert the rotational force from the rotors into a pull load force. A control module is configured to regulate the operation of the electric engine magnet field power compress device, the control module is adapted to control the magnetic field strength and manage the rotational and linear force output. A mechanical linkage device is connected to the electric engine magnet field power compress device for attaching to a load to be pulled by the vehicle.

In another embodiment, a method of generating a pull load force using an electric engine magnet field power compress device is disclosed. The method includes the steps of providing electrical power from a vehicle's power source to electromagnetic coils within the device to induce a magnetic field around a pair of rotors, rotating the rotors using the magnetic field, thereby generating a rotational thrust along a motor-driven rotary shaft that extends between the rotors, transmitting the rotational force of the shaft to a gear train disposed between the rotors, wherein the gear train converts high-speed rotation into a powerful pull load force, engaging a piston operatively connected to the shaft, the piston being moved linearly by the rotation of the shaft to generate a direct linear thrust on a flat surface, combining the rotational thrust and the linear thrust to amplify the pull load force, and transmitting the combined force through mechanical linkages to a load, thereby pulling the load.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the electric engine magnet field power compress device of the present invention in accordance with the disclosed structure;

FIG. 2 illustrates a schematic view showing the connection of the electric engine magnet field power compress device of the present invention with the external components in accordance with the disclosed structure;

FIG. 3 illustrates a close-up view of the magnetic connection used for attaching the piston and the motor-driven rotary shaft in accordance with the disclosed structure; and

FIG. 4 illustrates a flow chart depicting a method of use of the electric engine magnet field power compress device of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an electric engine system that can enhance the pull load force of electric trucks and heavy-duty vehicles. There is also a long-felt need in the art for a pull load generation system that reduces the dependency on traditional internal combustion engines. Additionally, there is a long-felt need for a pulling mechanism that combines the advantages of electromagnetic and mechanical systems to produce a powerful and controlled pull force suitable for moving heavy loads like cargo, machinery, and trailers. Moreover, there is a long-felt need for an electric pulling device that can be easily integrated into existing vehicles. Further, there is a long-felt need for a pulling system that offers precise control over the pulling force to ensure safe and efficient operation in diverse terrains and conditions. Finally, there is a long-felt need in the art for a device that maximizes the power-to-weight ratio of electric vehicles, improving both their performance and operational efficiency.

The present invention, in one exemplary embodiment, is a vehicle system for pulling heavy loads. The system includes an electric engine magnet field power compress device securely mounted to a frame or chassis of the vehicle. The device comprises a pair of rotors having electromagnetic coils configured to produce a magnetic field, a motor-driven rotary shaft extends between the rotors and includes a first and second bend, a piston is operatively connected to the shaft and is configured to generate a linear thrust, and a gear train is configured to convert the rotational force from the rotors into a pull load force. A mechanical linkage device is connected to the electric engine magnet field power compress device for attaching to a load to be pulled by the vehicle.

Reference will now be made in detail to the present preferred embodiments of the invention, examples of which are illustrated in the accompanying drawings. Wherever possible, the same reference numerals are used in the drawings and the description to refer to the same or like parts.

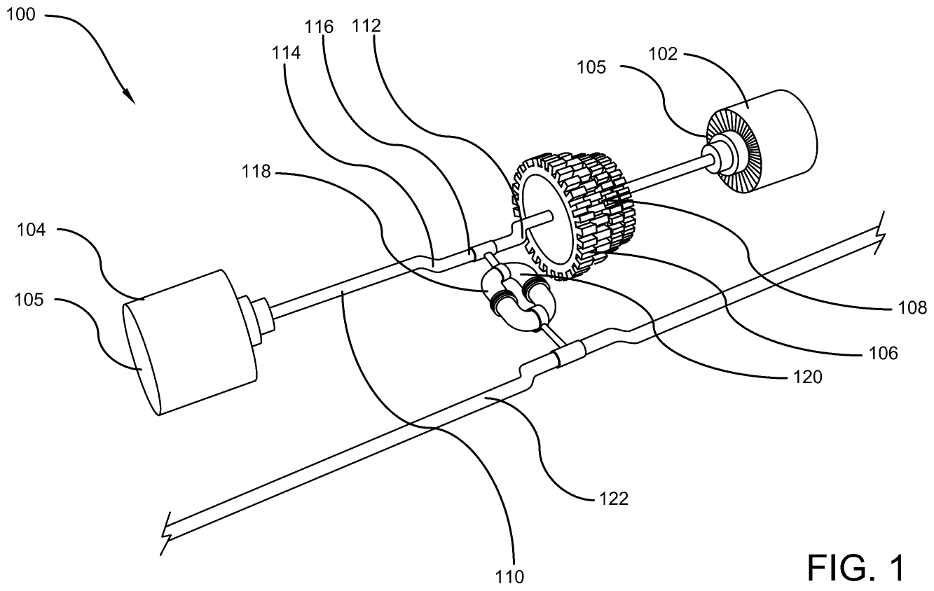

Referring initially to the drawings, FIG. 1 illustrates a perspective view of the electric engine magnet field power compress device 100 of the present invention in accordance with the disclosed structure. The electric engine magnet field power compress device 100 is preferably a mechanical device designed to generate a powerful pull load force using the combination of an electric magnetic field and piston power. Specifically, the device 100 is configured to enhance the pulling power of electric engines to pull heavy objects for vehicles such as, but not limited to, trucks, haulers, and industrial machinery transporters. In use, the device 100 is securely mounted to the frame or chassis of the vehicle, and it can be fastened using bolts, brackets, and other fasteners that ensure stability under high-torque conditions, minimizing vibration and mechanical stress.

The device 100 comprises at least one pair of rotors 102, 104. The rotors 102, 104 are equipped with at least one magnet 105, which can take the form of electromagnetic coils or permanent magnets. The electromagnetic coils are preferably made of copper or aluminum windings for improved conductivity, while the permanent magnets may be composed of materials like neodymium or samarium-cobalt for a higher magnetic flux density. The magnets 105 are configured to generate a variable magnetic field that drives the mechanical components of the device 100, as will be described more fully below. The rotors 102, 104 form the motor of the device 100 and are constructed from soft magnetic materials such as silicon steel or iron-cobalt alloy to enhance the efficiency of magnetic field generation and minimize eddy current losses. The rotor diameters can range from 150 mm to 500 mm, allowing for customization based on the desired power output of the device 100. Further, the rotors 102, 104 can have between 4 to 12 poles, facilitating higher magnetic interaction, which allows for smoother and more controlled generation of pull load force.

The device 100 further comprises at least one gear train 106, including at least one set of interconnected gears 108 disposed between the rotors 102, 104. The gear train 106 is connected to the rotors 102, 104 using at least one motor-driven rotary shaft 110. The shaft 110 extends between the rotors 102, 104 and functions as the primary axis of the device 100. It is designed to transfer the rotational force generated by the rotors 102, 104 directly to the gear train 106. The gears 108 may include spur gears, helical gears, or bevel gears, depending on the torque and speed requirements, allowing the device 100 to convert high-speed rotation into a more powerful pull load force suitable for heavy-duty applications.

The shaft 110 comprises a first bend 112 and a second bend 114 positioned between the second rotor 104 and the gear train 106. The bent portion 116 of the shaft 110 includes connectors 118, 120 for interfacing with a piston 122. The shaft 110 is predominantly straight to enable direct transmission of rotational force from the rotors 102, 104 while incorporating bends 112, 114 to accommodate alignment with the piston 122. The shaft 110 has a circular cross-section, with diameters ranging from 30 mm to 80 mm, providing the necessary mechanical strength to endure torsional forces generated during operation without compromising structural integrity.

The piston 122 is configured to generate thrust on a flat surface and is pushed and pulled linearly along the flat surface through the rotational motion of the shaft 110. The piston action contributes to the pulling force by providing direct linear thrust, which can be harnessed for pulling heavy loads such as large vehicles, construction equipment, or other weighty objects. The device 100 combines the linear thrust from the piston 122 and the rotary thrust from the motor-driven rotary shaft 110 to maximize the pull load force, enhancing its utility in the industrial, automotive, and transportation sectors.

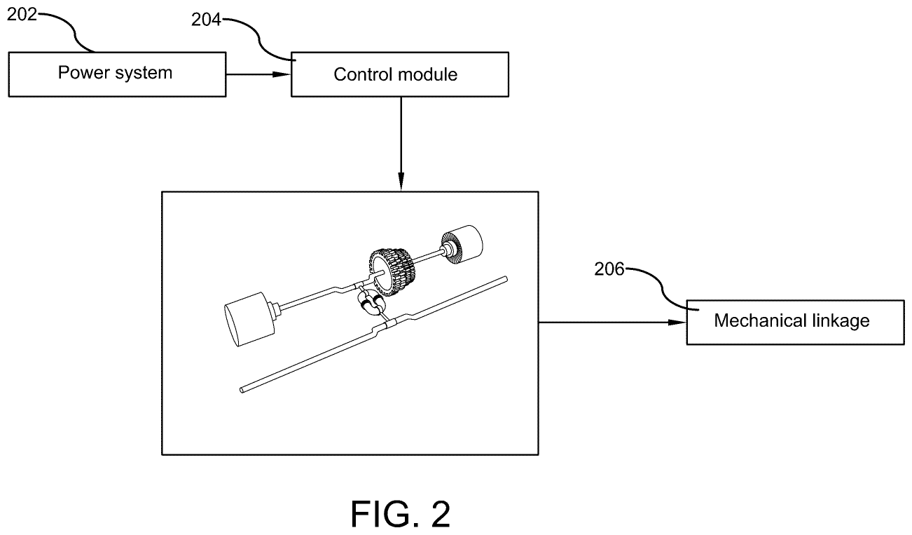

FIG. 2 illustrates a schematic view showing the connection of the electric engine magnet field power compress device 100 with external components, in accordance with the disclosed structure. The device 100 is connected to the vehicle's power system 202, which supplies electrical power to generate a magnetic field through the electromagnetic coils within the rotors 102, 104. Upon activation of the vehicle's ignition, electrical power is delivered to the electromagnetic coils, establishing a consistent magnetic field. This magnetic field induces rotation in the shaft 110, and simultaneously, a linear thrust is generated in the piston 122.

A control module 204 is adapted to regulate the operation of the electric engine magnet field power compress device 100. The control module 204 is responsible for managing fluctuations in the electric current supplied to the rotors, thus controlling the output of rotational and linear force. Preferably, the control module 204 comprises a switch, relay, or a microcontroller configured with feedback mechanisms, such as temperature and current sensors, to ensure efficient operation. The control module 204 can automatically shut down the device 100 in response to overheating, preventing damage from overload conditions. The device 100 is linked to the load to be pulled via a mechanical linkage 206, which may comprise cables, hooks, or chains, designed to withstand the tensile forces generated during operation.

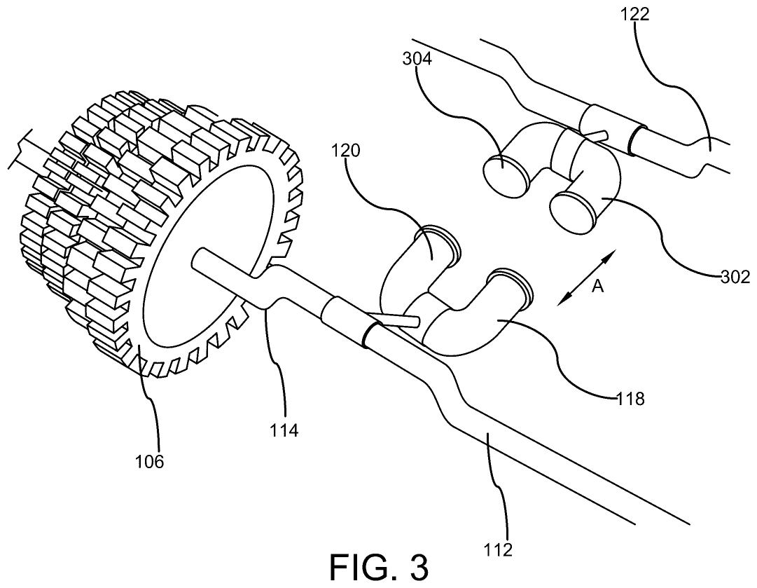

FIG. 3 illustrates a detailed view of the magnetic coupling between the piston 122 and the motor-driven rotary shaft 110. The magnetic connectors 118, 120 are mounted on the shaft 110 and can slide along the bent portion 116 of the shaft 110. As the shaft 110 rotates due to the magnetic field produced by the rotors 102, 104, the connectors 118, 120 move laterally as indicated by arrow “A”. A corresponding magnetic connector set, including connectors 302, 304, is disposed on the piston 122, which are operatively coupled with the connectors 118, 120. This arrangement facilitates the linear movement of the piston 122, providing direct linear thrust for pulling heavy loads with minimal friction loss.

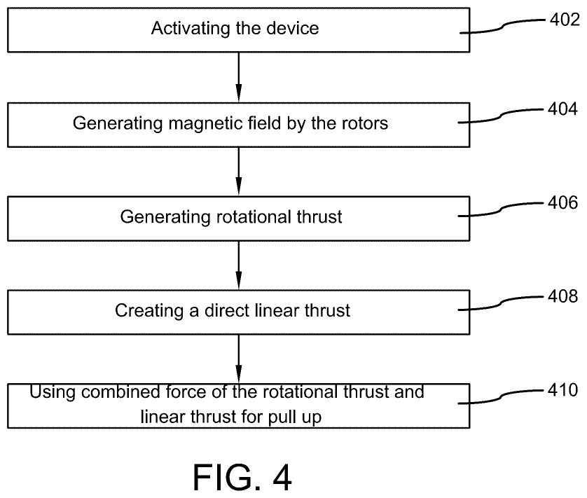

FIG. 4 illustrates a flowchart depicting a method of using the electric engine magnet field power compress device 100. Initially, an activation signal from the control system is received, initiating activation of the device, and electrical power is provided from the vehicle's power source to the device (Step 402). The power is directed to the electromagnetic coils within the rotors 102, 104. Subsequently, the electric current flows through the coils, generating a magnetic field around the rotors 102, 104, and causing them to rotate (Step 404). The rotation of the rotors generates a rotational thrust along the shaft 110 (Step 406), providing the first component of the pulling power.

Concurrently, the magnetic field induces linear motion in the piston 122, creating a direct linear thrust on a flat surface (Step 408). As the piston 122 moves, it further compresses the magnetic field, amplifying the linear force generated by the device's integrated electromagnetic and piston drive system. The combined force of rotational and linear thrust is then transmitted through mechanical linkages, such as cables, chains, or a hitch, to the load that is to be pulled (Step 410). After completing the pulling task, the power supplied to the electromagnetic coils is reduced, leading to a decrease in magnetic field strength, which in turn slows the rotation of the rotors 102, 104 and the movement of the piston 122. This process ensures controlled deceleration, preventing abrupt stops that could strain the mechanical components.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “magnetic power pull engine device”, “electric engine magnet field power compress device”, “integrated electromagnetic and piston drive system”, and “device” are interchangeable and refer to the integrated electromagnetic and piston drive device 100 of the present invention.

Notwithstanding the forgoing, the integrated electromagnetic and piston drive device 100 of the present invention can be of any suitable size and configuration as is known in the art without affecting the overall concept of the invention, provided that it accomplishes the above-stated objectives. One of ordinary skill in the art will appreciate that the integrated electromagnetic and piston drive device 100 as shown in the FIGS. are for illustrative purposes only, and that many other sizes and shapes of the integrated electromagnetic and piston drive device 100 are well within the scope of the present disclosure. Although the dimensions of the integrated electromagnetic and piston drive device 100 are important design parameters for user convenience, the integrated electromagnetic and piston drive device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A magnetic power pull engine device comprising:
a first rotor made from a soft magnetic material and comprised of a magnet configured to generate a variable magnetic field;
a second rotor made from a soft magnetic material and comprised of a magnet configured to generate a variable magnetic field;
a motor-driven rotary shaft extending between the first rotor and the second rotor, the rotary shaft being configured to transfer rotational force generated by the first rotor and the second rotor;
a gear train including a set of interconnected gears, the gear train being operatively connected to the motor-driven rotary shaft to convert rotational motion into a pulling force;
a piston configured to generate linear thrust along a flat surface, the piston being operatively coupled to the motor-driven rotary shaft through a bent portion of the shaft, wherein the bent portion includes connectors for interfacing with the piston; and
a control module that controls an electric current supplied to the first rotor and the second rotor.

2. The magnetic power pull engine device of claim 1, wherein the first rotor and the second rotor are comprised of a neodymium or a samarium-cobalt.

3. The magnetic power pull engine device of claim 1, wherein the first rotor and the second rotor have a diameter ranging from 150 mm to 500 mm.

4. The magnetic power pull engine device of claim 1, wherein the gear train is comprised of a spur gear, a helical gear, or a bevel gear.

5. The magnetic power pull engine device of claim 1, wherein the motor-driven rotary shaft is comprised of a circular cross-section with a diameter ranging from 30 mm to 80 mm.

6. The magnetic power pull engine device of claim 1, wherein the bent portion of the motor-driven rotary shaft includes a first bend and a second bend for accommodating alignment with the piston.

7. The magnetic power pull engine device of claim 1, wherein the control module comprises a microcontroller.

8. The magnetic power pull engine device of claim 7, wherein the microcontroller regulates the power supply.

9. The magnetic power pull engine device of claim 1 further comprised of a mechanical linkage.

10. The magnetic power pull engine device of claim 9, wherein the mechanical linkage is comprised of a cable, a hook, or a chain.

11. A magnetic power pull engine device comprising:
a first rotor comprised of a first electromagnetic coil and a second rotor comprised of a second electromagnetic coil, the first rotor and the second rotor configured to generate a magnetic field, and wherein the first rotor and the second rotor are attached to a motor-driven rotary shaft;
a gear train disposed between the first rotor and the second rotor comprising a set of gears, the gear train designed to convert a rotational force from the rotary shaft into a pulling force;
a piston configured to provide linear thrust, the piston being operatively connected to the motor-driven rotary shaft via a bent portion that includes a connector for aligning the piston;
a control module configured to adjust a flow of electrical power to the first electromagnetic coil and the second electronic magnetic coil to modulate an output of rotational thrust and the linear thrust; and
a mechanical linkage.

12. The magnetic power pull engine device of claim 11, wherein the first electromagnetic coil and the second electromagnetic coil are comprised of a copper winding.

13. The magnetic power pull engine device of claim 11, wherein the first electromagnetic coil and the second electromagnetic coil are comprised of an aluminum winding.

14. The magnetic power pull engine device of claim 11, wherein the mechanical linkage is comprised of a cable, a hook, or a chain.

15. A magnetic power pull engine device comprising:
a pair of rotors comprised of a first rotor and a second rotor, the first rotor equipped with a first electromagnetic coil or a first permanent magnet and the second rotor equipped with a second electromagnetic coil or a second permanent magnet, the first rotor and the second rotor being coupled to a motor-driven rotary shaft;
a gear train coupled to the motor-driven rotary shaft, the gear train being configured to convert a rotational motion into a pulling force;
a piston assembly interfaced with the rotary shaft, the piston assembly comprised of a piston configured to generate a linear thrust along a flat surface;
a bent portion of the rotary shaft comprising a connector for engaging the piston assembly to facilitate a linear movement; and
a control module comprising a sensor for monitoring a temperature and a current, the control module being configured to regulate the operation of the first rotor, the second rotor, and the piston assembly, and to provide controlled deceleration of the magnetic power pull engine device during power reduction.

16. The magnetic power pull engine device of claim 15, wherein the piston assembly is configured to compress the magnetic field during operation, thereby amplifying a linear force.

17. The magnetic power pull engine device of claim 15, wherein the control module is comprised of a relay or a switch.

18. The magnetic power pull engine device of claim 15, wherein the bent portion of the rotary shaft is positioned between the second rotor and the gear train.

19. The magnetic power pull engine device of claim 15, wherein the connector is comprised of a magnetic connector.

20. The magnetic power pull engine device of claim 15, wherein the sensor is comprised of a temperature sensor or a current sensor.
